(19) United States
(12) Patent Application Publication
(10) Pub. No.: US 2024/0283181 A1
(43) Pub. Date: Aug. 22, 2024

(54) PLUG-IN CONNECTION SYSTEM, PLUG-IN CONNECTION ELEMENT AND PLUG-IN CONNECTION

(71) Applicant: Lisa Dräxlmaier GmbH, Vilsbiburg (DE)

(72) Inventor: Dalibor KRIVOHLAVEK, Ingolstadt (DE)

(73) Assignee: Lisa Dräxlmaier GmbH, Vilsbiburg (DE)

(21) Appl. No.: 18/582,930

(22) Filed: Feb. 21, 2024

(30) Foreign Application Priority Data
Feb. 21, 2023 (DE) 10 2023 104 274.2

(51) Int. Cl. H01R 13/193; H01R 13/629

(52) U.S. Cl. CPC H01R 13/193; H01R 13/62955

(57) ABSTRACT

The invention relates to a plug-in connection system (1), to a plug-in connection element (2, 3) and to a plug-in connection (4). The plug-in connection system (1) comprises a locking mechanism (5), the actuating lever (6) of which is pivotably mounted on a cover (7) of the first plug-in connection element (2) and is pivotable between two lever end positions. The locking mechanism (5) is arranged, in the second lever end position, in a locking position in which a form-fitting element (9) of the first plug-in connection element (2) and a form-fitting element (11) of the second plug-in connection element (3) form a locking form-fitting engagement which tensions the plug-in connection elements (2, 3) against one another. In the first lever end position, the locking mechanism (5) is arranged in an unlocking position in which the locking form-fitting engagement is released. A securing slide (12) is mounted so as to be movable in translation in the actuating lever (6) of the locking mechanism (5) and is adjustable between a securing position, in which a securing pin (13) of the securing slide (12) engages in a securing pin receptacle (14) of the cover (7), as a result of which a securing form-fitting engagement is formed between the cover (7) and the actuating lever (6), and a securing-release position, in which the securing form-fitting engagement is released.

### TECHNICAL FIELD

The present invention relates to a plug-in connection system comprising a first plug-in connection element (for example a plug) and a second plug-in connection element (for example a socket). Furthermore, the invention relates to a plug-in connection element for the plug-in connection system and to a plug-in connection produced by means of the plug-in connection system. The plug-in connection system, the plug-in connection element and the plug-in connection are in particular intended for a motor vehicle, that is to say for connecting two cable harnesses, for connecting a cable harness to a control device, etc.

### PRIOR ART

In conventional plug-socket connections which are secured or able to be secured against unintentional releasing or unplugging by means of a locking mechanism, it is nowadays known for the locking mechanism to be entirely or fully covered so that the locking mechanism cannot be unintentionally unlocked. What is referred to as a CPA arrangement (CPA: Connection Position Assurance) is also known, which in its securing position inhibits or blocks unlocking of the locking mechanism. However, these conventional approaches do not offer any possibility of securing the plug-socket connection against an excessive release force. Such an excessive release force may, for example on account of misuse or unintentional pulling on a cable harness connected to the plug-socket connection, have an effect on the plug-socket connection. Thus, although the conventional approaches protect against unintentional releasing/unlocking of the locking mechanism, they do not protect against an excessive pulling force on the locked plug-socket connection.

### DESCRIPTION OF THE INVENTION

It is the object of the invention to particularly firmly connect two mutually corresponding plug-in connection elements (in particular in the automotive sector) to one another and to reliably keep them connected.

This object is achieved by the subjects of the independent patent claims. Further possible refinements of the invention are disclosed in the dependent claims, the description and the figures. Features, advantages and possible refinements that are presented in the context of the description for one of the subjects of the independent claims should be considered, across categories and embodiments, to at least analogously be features, advantages and possible refinements of the respective subject of the other independent claims and any possible combination of the subjects of the independent claims, where applicable in connection with one or more of the dependent claims.

According to the invention, a plug-in connection system comprising a first plug-in connection element and a second plug-in connection element is proposed. Here, the plug-in connection elements correspond to one another to form a plug-in connection. Furthermore, the invention relates to a plug-in connection element which is purposefully designed to function as part of the plug-in connection system. In this case, the plug-in connection element is embodied as a plug or as a socket or as a mixed construction with a plug part and a socket part. The invention also relates to a plug-in connection produced by means of the plug-in connection system.

The plug-in connection system comprises a locking mechanism. The locking mechanism comprises an actuating lever which is pivotably mounted on a cover (that is to say on a cover upper part or on a cover lower part of the cover) of the first plug-in connection element. In this way, the actuating lever is pivotable between a first lever end position and a second lever end position. The locking mechanism is arranged, in the second lever end position, in a locking position in which a first form-fitting element of the first plug-in connection element and a second form-fitting element of the second plug-in connection element together form a locking form-fitting engagement which tensions the plug-in connection elements against one another. By contrast, in the first lever end position of the actuating lever, the locking mechanism is arranged in an unlocking position in which the locking form-fitting engagement is released. In order to thus produce the plug-in connection by means of the plug-in connection system, provision is made—if it has not yet been done—for the actuating lever to be adjusted into the first lever end position, as a result of which the locking mechanism is adjusted into the unlocking position. After this, the two plug-in elements are positioned against one another and pushed toward one another as intended until the form-fitting elements are pre-positioned relative to one another to form the locking form-fitting engagement. After this, the actuating lever is pivoted from the first lever end position to the second lever end position, wherein, with the plug-in connection elements tensioned against one another, the locking form-fitting engagement is formed and closed. To release the plug-in connection, provision is made for the process to be performed in reverse order.

Furthermore, the plug-in connection system comprises a securing slide which is mounted so as to be movable in translation in the actuating lever of the locking mechanism. Here, the securing slide is adjustable between a securing position and a securing-release position by virtue of the securing slide being moved in translation in the securing direction or securing-release direction. In the securing position, a securing pin of the securing slide form-fittingly engages in a securing pin receptacle of the cover, as a result of which a securing form-fitting engagement is formed between the cover and the actuating lever. In the securing-release position, the securing form-fitting engagement is released.

In the securing position, unintentional adjustment of the actuating lever from its second lever end position to its first lever end position is thus prevented by virtue of the securing pin engaging in the securing pin receptacle. In other words, a form-fitting connection between the actuating lever and the cover is produced and inhibits the pivoting of the actuating lever out of its first lever end position. Thus, in the case of the plug-in connection system, the plug-in connection between the plug-in connection elements is firstly secured against unintentional adjustment of the actuating lever into the first lever end position and the actuating lever is secondly secured against forcible adjustment into its first lever end position.

In the case of the plug-in connection system, it is in particular conceivable for a second securing pin receptacle to be provided which is firmly connected to the second plug-in connection element, such that a second securing form-fitting engagement between the second plug-in connection element and the actuating lever is produced. The second securing pin receptacle can be provided as an alternative or in addition to the aforementioned (first) securing pin receptacle. For particularly simple operation of the securing slide, the latter can comprise an actuating surface element, which is purposefully embodied as a tool engagement surface and/or as a finger engagement surface.

It is furthermore conceivable for the first plug-in connection element of the plug-in connection system to comprise a cover upper part and a cover lower part, from which the cover of the first plug-in connection element is formed. The first plug-in connection element also comprises a snap-action hook device comprising a snap-action hook and a snap-action hook receptacle. In this case, the snap-action hook is firmly connected to the cover upper part of the cover of the first plug-in connection element, whereas the snap-action hook receptacle is firmly connected to the cover lower part of the cover of the first plug-in connection element. A reversed arrangement of the snap-action hook device, in which the snap-action hook is arranged on the cover lower part and the snap-action hook receptacle is arranged on the cover upper part, is also conceivable. In particular, the first plug-in connection element comprises two or more snap-action hook devices. The cover of the first plug-in connection element is thus composed of the cover upper part and the cover lower part, which are fastened to one another by means of a snap-action hook connection or multiple snap-action hook connections. In this case, the respective snap-action hook device is particularly sturdy in comparison with conventional snap-action hook devices, as a result of which the cover upper part and the cover lower part are particularly securely and reliably fixed to one another. It is nevertheless possible for the first plug-in connection element to be produced in a particularly simple manner and to be reversibly non-destructively disassembled (using a suitable tool). An initial equipping of the first plug-in connection element with electrical contacting elements (contacting pins and/or bushings, etc.) and a change of the initial equipping are thus particularly simple and inexpensive. However, a force which has to be applied in order to separate the plug-in connection elements—in particular the cover upper part and the cover lower part of the—from one another is advantageously particularly great, as a result of which a reliable and particularly stable plug-in connection is ensured.

In a further possible embodiment of the plug-in connection system, the actuating lever comprises a latching projection, wherein the cover comprises a latching spring bar which corresponds to the latching projection. In this case, the latching spring bar is arranged, in the first lever end position, in a non-tensioned starting position. The latching spring bar is able to be reversibly elastically tensioned, with adjustment of the actuating lever from its first lever end position in the direction of the second lever end position, from the starting position of said latching spring bar into a latching position by virtue of the latching projection sliding along the latching spring bar. In other words, the latching spring bar is tensioned from the starting position into the latching position by virtue of the latching projection displacing, with movement of the actuating lever in the direction of the second lever end position, the latching spring bar out of its original position (starting position). In the second lever end position, the latching spring bar is arranged in a non-tensioned latching securing position, wherein the latching spring bar and the latching projection together establish a latching securing connection between the actuating lever and the cover. This means that the latching spring bar springs back from its tensioned latching position into the non-tensioned starting position, and in so doing engages over or overlaps the latching projection, such that the actuating lever is additionally secured in its second lever end position.

A further possible embodiment of the plug-in connection system provides, in connection with the latching spring bar, for the securing pin receptacle to be formed by a passage opening which passes through the latching spring bar. This means that, in the securing state of the securing slide, the securing pin projects into the passage opening, in particular projects through the passage opening, such that pivoting of the actuating lever is inhibited on account of the securing pin arranged in the passage opening.

According to a further possible refinement of the plug-in connection system, provision is made for the passage opening to have an inner peripheral surface which corresponds to an outer peripheral surface of the securing pin. The inner peripheral surface comprises a tilt lock part, wherein the tilt lock part and the outer peripheral surface of the securing pin lie directly against one another when the securing form-fitting engagement is closed. In other words, the passage opening lies directly against the securing pin by means of its tilt lock part, provided that the securing form-fitting engagement is produced or closed as intended. The tilt lock part extends along an X axis or longitudinal axis of the first plug-in connection element over a determined length, such that, in the case of the securing form-fitting engagement, the tilt lock part does not only lie against or rest on the securing pin in a punctiform manner but also in an areal manner. This is because in order to tension the latching spring bar to move out the actuating lever into the release position, an edge of the passage opening would have to be moved along a path which is obstructed by the securing pin. As a result, tilting or tensioning of the latching spring bar is effectively inhibited, as a result of which security against unintentional, in particular improper adjustment of the actuating lever is once again increased.

A further possible embodiment of the plug-in connection element provides for the securing slide to comprise an elastically reversibly tensionable arresting element, wherein the actuating lever comprises an arresting element receptacle. The arresting element is arranged, with adjustment of the securing slide in the direction of the securing position, in a tensioned release position. In the securing position of the securing slide, the arresting element is arranged in a non-tensioned arresting position, wherein the arresting element engages in the arresting element receptacle in such a way that an arresting surface of the arresting element lies against an edge of the arresting element receptacle, as a result of which the adjustment of the securing slide in the direction of the securing-release position is arrested. In this document, the expression “arrest” in connection with the arresting element should be understood to mean that the adjustment of the securing slide is at least impeded when the arresting element in its non-tensioned arresting position engages in the arresting element receptacle. By means of the arresting element arranged in the arresting position, the securing slide is thus held in the securing position or is secured against unintentional moving out of the securing position.

In connection with the arresting element, a further possible embodiment of the plug-in connection system provides for the arresting surface to be parallel to a vertical axis (z) of the actuating lever and to form an angle with a longitudinal vertical plane (XZ). This angle may be 90 degrees, then the arresting element must be tensioned into the release position manually or by means of a tool in order to then be able to move the securing slide out of its securing position. The angle is in particular greater than 0 degrees and smaller than 90 degrees, wherein a force which has to be applied in order to move the securing slide out of its securing position is dependent on said angle. This means that, when producing or designing the plug-in connection system, the desired release force for moving the securing slide out of its securing position can be predefined as required, specifically by predefining the angle between the arresting surface and the longitudinal vertical plane (XZ).

In a possible development of the plug-in connection system comprising the arresting element, provision is made—when the locking mechanism is moved out of its locking position and the securing slide is arranged in its securing-release position—for the arresting element to be arranged in a non-tensioned blocking position. In the blocking position, a blocking surface of the arresting element abuts against a blocking element of the actuating lever, as a result of which adjustment of the securing slide in the direction of the securing position is blocked. Furthermore, the arresting element is able to be tensioned from the blocking position into the release position by virtue of an arresting element edge of the arresting element sliding, with adjustment of the locking mechanism into the locking position, against a sliding surface of the first plug-in connection element. The sliding surface may be formed, for example, by an outer surface of a plug cover, provided that the first plug-in connection element is such a plug. Furthermore, the sliding surface may be an outer surface of the cover on which the actuating lever is pivotably mounted. A general rule for the present description is that the cover may be formed by such a plug cover.

By virtue of adjustment of the securing slide being prevented by the arresting element arranged in the blocking position, accidental operation of the securing slide is ruled out, such that when producing the plug-in connection, adjustment of the actuating lever into its second end position is not prevented by the securing slide. In other words: The securing slide is only adjustable from its securing-release position into its securing position when the actuating lever is completely arranged in the second lever end position, that is to say when the locking mechanism is completely arranged in the locking position. In particular, a general rule for the securing slide is that the latter is captively mounted in or on the actuating lever. By way of example, a further arresting element receptacle assigned to the securing-release position of the securing slide or to the blocking position of the arresting element functions as captive retention means by virtue of the arresting element engaging in the further arresting element receptacle in the securing-release position of the securing slide.

In a further possible embodiment, provision is made for the securing slide in the securing-release position to project along a longitudinal direction (x) of the actuating lever from an actuating end of the actuating lever and to form a lever extension of the actuating lever as a result. In other words, an actuating lever-securing slide construction is longer along the longitudinal direction (x) in the securing-release position of the securing slide than in the securing position of the securing slide. This advantageously makes it possible for a user, for example a fitter, producing the plug-in connection to have to apply less force to pivot the actuating lever from its first lever end position to the second lever end position. Consequently, the user has to apply less force to tension the plug-in connection elements against one another or to form the locking form-fitting engagement as intended.

In a further possible embodiment of the plug-in connection system, the securing slide comprises two sliding limbs, wherein the actuating lever comprises two sliding limb receptacles. In this case, the sliding limb receptacles and the sliding limbs correspond to one another, such that the securing slide is mounted so as to be movable in translation in the actuating lever by virtue of the sliding limbs each being arranged in the correspondingly associated sliding limb receptacle. This effectively prevents the securing slide from being guided insufficiently and tilted as a result when being adjusted into the securing position. Instead, uniform adjustment or displacement of the securing slide is ensured by virtue of it being doubly mounted so as to be movable in translation in the sliding limb receptacles.

Further advantages, features and details of the invention can emerge from the following description of possible exemplary embodiments and on the basis of the drawing. The features and feature combinations mentioned above in the description, and the features and feature combinations mentioned below in the description of the figures and/or shown only in the figures, may be used not only in the respectively specified combination but also in other combinations or individually, without departing from the scope of the invention.

### BRIEF DESCRIPTION OF THE FIGURES

In the drawing:

FIG. 1 shows a perspective view of a plug-in connection system comprising a locking mechanism and a securing slide, wherein an actuating lever of the locking mechanism is arranged in a first lever end position,

FIG. 2 shows a perspective detail view of a first plug-in connection element of the plug-in connection system with the actuating lever arranged in the first lever end position,

FIG. 3 shows a sectioned view of the plug-in connection system, wherein the actuating lever is arranged in a second lever end position,

FIG. 4 shows a sectioned detail view of the first plug-in connection element, wherein the actuating lever is arranged between the first and the second lever end position,

FIG. 5 shows a sectioned detail view of that part of the plug-in connection system which is shown in FIG. 4 in a state which is produced as a result of a further movement of the actuating lever in the direction of the second lever end position,

FIG. 6 shows a perspective view, sectioned along section plane VI-VI (see FIG. 3), of a part of the plug-in connection system, wherein the securing slide is arranged in the securing-release position,

FIG. 7 shows a perspective detail view, sectioned along section plane VII-VII (see FIG. 3), of a part of the first plug-in connection element, wherein the securing slide is arranged in the securing-release position,

FIG. 8 shows a sectioned detail view of a part of the first plug-in connection element, wherein the securing slide is arranged in a securing position, and

FIG. 9 shows a side view of the plug-in connection system, wherein the securing slide is arranged in the securing position.

A plug-in connection system 1, a plug-in connection element 2, 3 and a plug-in connection 4 which is produced or able to be produced by means of the plug-in connection system 1 are presented below in a common description. In this case, identical and functionally identical elements are denoted by the same reference sign in the figures. For a simple description, a coordinate system with the axes x, y and z is defined for the plug-in connection system. Here, the X direction is denoted as the longitudinal direction, the Y direction is denoted as the transverse direction and the Z direction is denoted as the vertical direction.

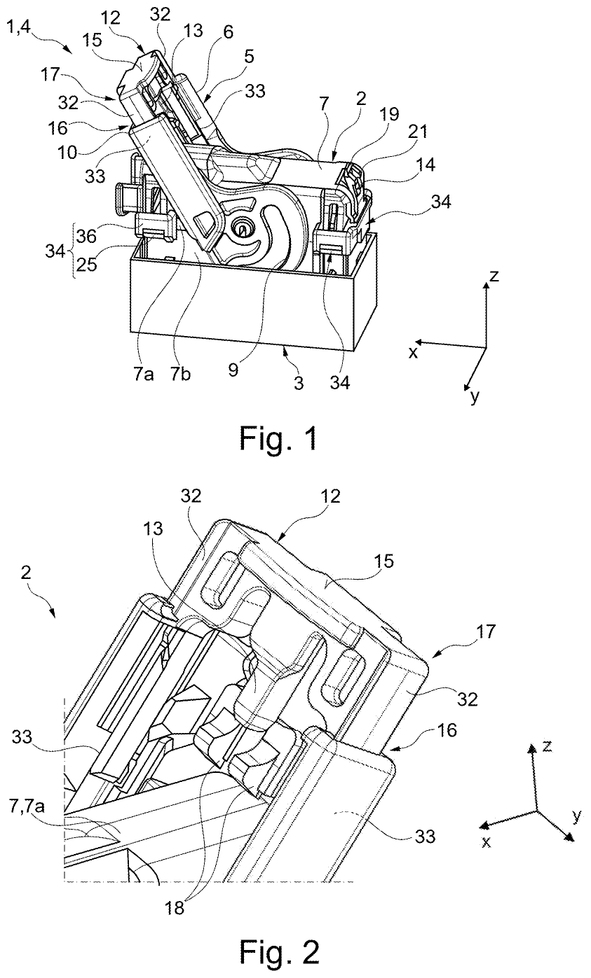

FIG. 1 shows a perspective view of the plug-in connection system 1, by means of which the plug-in connection 4 is produced by virtue of the two plug-in connection elements 2, 3 having been connected to one another as intended. Below, the plug-in connection element 2 is referred to as first plug-in connection element 2, whereas the plug-in connection element 3 is referred to as second plug-in connection element 3. This should not be understood as restrictive, but serves merely for the simpler description. One of the plug-in connection elements 2, 3 is embodied as a plug, whereas the correspondingly other one of the plug-in connection elements 2, 3 is in the form of a socket. It is also conceivable for one or both of the plug-in connection elements 2, 3 to be embodied as a mixed construction, the mixed construction comprising a plug part and a socket part. In the description below, the first plug-in connection element 2 is—non-restrictively—assumed to be a plug, wherein the second plug-in connection element 3 is assumed to be a socket, wherein the first plug-in connection element 2 or the plug and the second plug-in connection element 3 or the socket correspond to one another to form the plug-in connection 4.

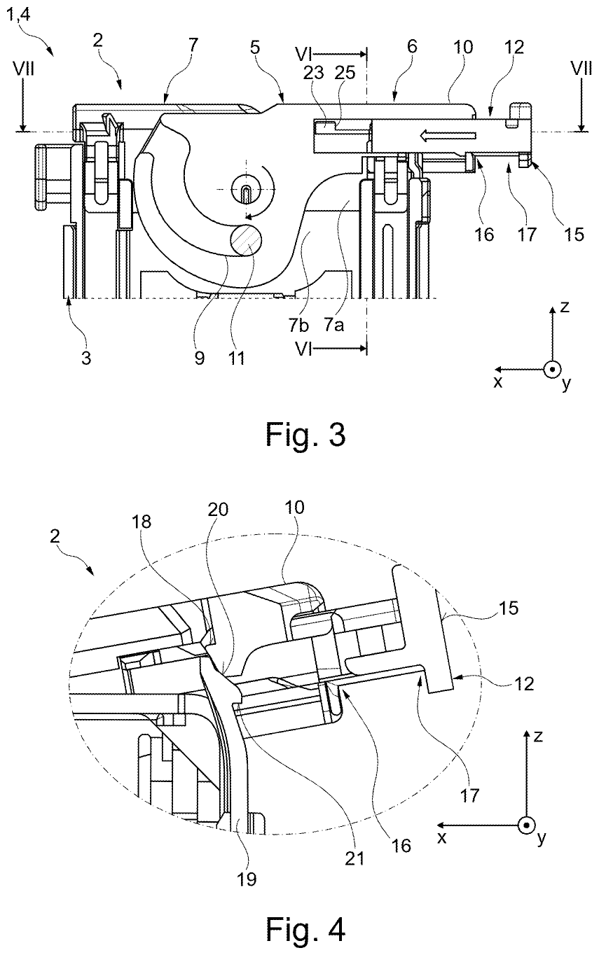

The plug-in connection system 1 comprises a locking mechanism 5 which comprises an actuating lever 6 which is pivotably mounted on a cover 7 of the first plug-in connection element 2. In the present case, the cover 7 of the first plug-in connection element 2 is formed from a cover upper part 7a and a cover lower part 7b, produced separately from said upper part, which are fixed to one another. This means the cover 7 or the first plug-in connection element 2 is a multi-part construction. Here, the actuating lever 6 is mounted on the cover lower part 7b or, as in the present example, on the cover upper part 7a. The locking mechanism 5 comprises a first form-fitting element 9 embodied as a form-fitting slot guide, said first form-fitting element being firmly connected to the actuating lever 6 and consequently being pivoted, with pivoting of the actuating lever 6, together with the latter. The actuating lever 6 is pivotable between a first lever end position and a second lever end position. In the first lever end position (as illustrated in FIG. 1), an actuating portion 10 of the actuating lever 6 points, for example, at least roughly in the Z direction, whereas the actuating portion 10 in the second lever end position (see FIG. 3) points, for example, at least roughly counter to the X direction.

For better clarity, FIG. 2 shows another perspective of the first plug-in connection element 2 in a detail view, wherein the actuating lever 6 is arranged in the first lever end position.

FIG. 3 shows a sectioned view of the plug-in connection system 1, wherein the actuating lever 6 is arranged in the second lever end position. In the second lever end position, the locking mechanism 5 is arranged in a locking position in which the first form-fitting element 9—here the form-fitting slot guide—of the first plug-in connection element 2 and a second form-fitting element 11 of the second plug-in connection element 3—here a form-fitting pin which corresponds to the form-fitting slot guide—together form a locking form-fitting engagement which tensions the plug-in connection elements 2, 3 against one another. By contrast, in the first lever end position (see FIG. 1 and FIG. 2), the locking mechanism 5 is arranged in a securing-release position in which the locking form-fitting engagement is released by virtue of the form-fitting elements 9, 11 not forming a form-fitting engagement together.

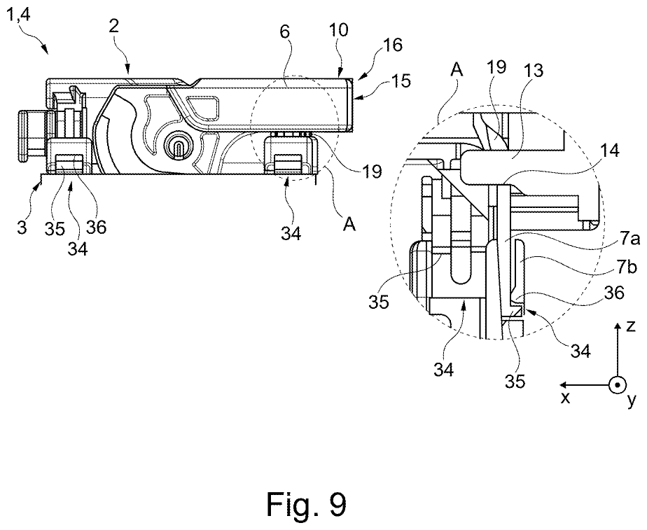

The plug-in connection system 1 also comprises a securing slide 12 which is mounted so as to be movable in translation in or on the actuating lever 6 of the locking mechanism 5. In this case, the securing slide 12 is adjustable between a securing-release position (see FIG. 1 to FIG. 7) and a securing position (see FIG. 8 and FIG. 9). In the securing position of the securing slide, the securing pin 13 of said securing slide (see FIG. 1 and FIG. 2) form-fittingly engages in a securing pin receptacle 14 (see FIG. 1) of the cover 7. As a result, a securing form-fitting engagement is formed between the cover 7 and the actuating lever 6. In a first variant of the plug-in connection system 1, provision is made for the securing pin receptacle 14 to be firmly connected to the second plug-in connection element 3. In yet a further possible variant of the plug-in connection system 1, provision is made for it to comprise a first securing pin receptacle 14 on the cover 7 and a second securing pin receptacle on the second plug-in connection element 3. In this case, the securing pin 13 engages in both securing pin receptacles in the securing position of the securing slide.

If the securing slide 12 is arranged in the securing-release position, the securing form-fitting engagement between the securing pin 13 and the securing pin receptacle 14 is released or opened. In the securing-release position, the actuating lever 6 is thus able to be pivoted out of its second lever end position, whereas the actuating lever 6 is reversibly and non-destructively releasably fixed in the second lever end position in the securing position of the securing slide 12.

Furthermore, it is clear from FIG. 3 that the securing slide 12 comprises an actuating surface element 15 which is purposefully embodied as a tool engagement surface and/or as a finger engagement surface.

FIG. 4 shows a sectioned detail view of the first plug-in connection element 2, wherein the actuating lever 6 is arranged between the first and the second lever end position. This means FIG. 4 shows the first plug-in connection element 2 in a state in which the actuating lever 6 is, for example, pivoted in the direction of its second lever end position in order to produce the plug-in connection 4. Firstly, it is apparent (in particular viewing FIGS. 1-3 together) that the securing slide 12 in its securing-release position projects along a longitudinal direction x of the actuating lever 6 from an actuating end 16 of the actuating lever 6, as a result of which a lever extension 17 of the actuating lever 6 is formed. Secondly, it is apparent from FIG. 4 that the actuating lever 6 comprises a latching projection 18, wherein the cover 7 comprises a latching spring bar 19 which corresponds to the latching projection 18. When the actuating lever 6 is adjusted from its first lever end position to its second lever end position, cooperation between the latching projection 18 and the latching spring bar 19 is constituted as follows: In the first lever end position, the latching spring bar 19 is arranged in a non-tensioned starting position until—owing to the movement of the actuating lever 6 in the direction of its second lever end position—the latching projection 18 strikes against the latching spring bar 19. When the actuating lever 6 is adjusted further in the direction of the second lever end position, the latching spring bar 19 is reversibly elastically tensioned from its starting position, specifically into a latching position. In this case, the latching spring bar 19 is tensioned by virtue of the latching projection 18 sliding along the latching spring bar 19, for example along a sliding surface 20 of the latching spring bar 19 that is provided for this purpose. This state is depicted in FIG. 4. FIG. 4 thus shows a state of the plug-in connection system 1 at the beginning of the activation of the latching spring bar 19.

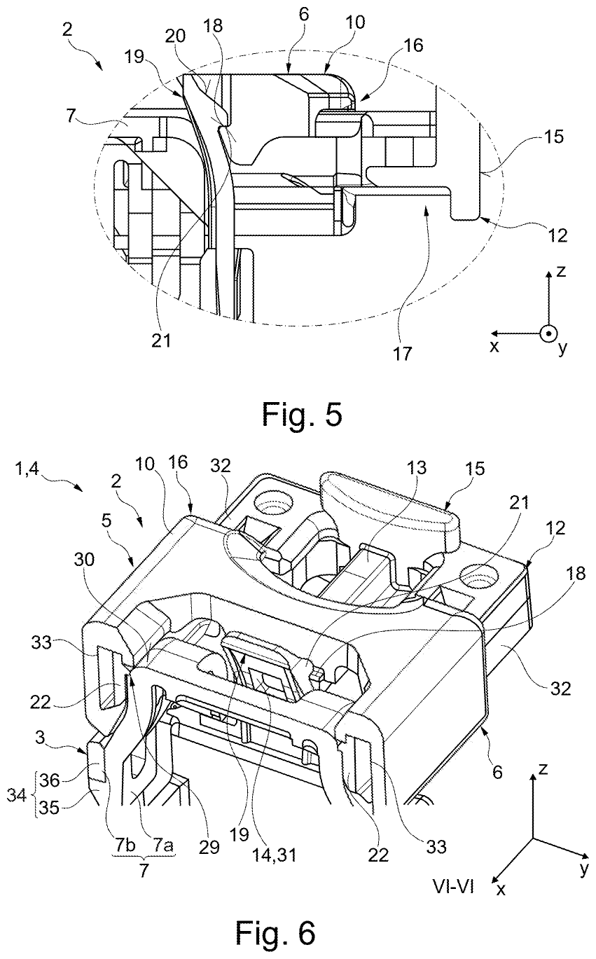

FIG. 5 shows a sectioned detail view of that part of the first plug-in connection element 2 which is shown in FIG. 4 in a state which is produced as a result of a further movement of the actuating lever 6 in the direction of the second lever end position, that is to say in a locking state of the actuating lever 6. The securing slider 12 is still arranged in its securing-release position in FIG. 5. As soon as the actuating lever 6 is completely arranged in the second lever end position, the latching spring bar 19 is at least partially relieved of tension again, wherein a latching wedge 21 of the latching spring bar 19 engages over or overlaps the latching projection 18 in relation to the Z direction, such that a latching securing connection is established between the actuating lever 6 and the cover 7 by means of the latching spring bar 19 and the latching projection 18. In this case, the latching spring bar 19 is arranged in a latching securing position in which it is relieved of tension in comparison with the latching position. The latching spring bar 19 may still be tensioned in comparison with the starting position. To release the latching securing position, provision is made for the latching spring bar 19 to be tensioned from the latching securing position into the latching position, for example by means of a correspondingly suitable tool, by means of a finger etc., as a result of which the latching projection 18 is then released for a movement in the Z direction.

FIG. 6 shows a perspective view, sectioned along section plane VI-VI (see FIG. 3), of a part of the plug-in connection system 1 or of the plug-in connection 4, wherein the securing slide 12 is arranged in the securing-release position. Here, it is apparent that the actuating lever 6 is completely arranged in its second lever end position (cf. FIG. 5).

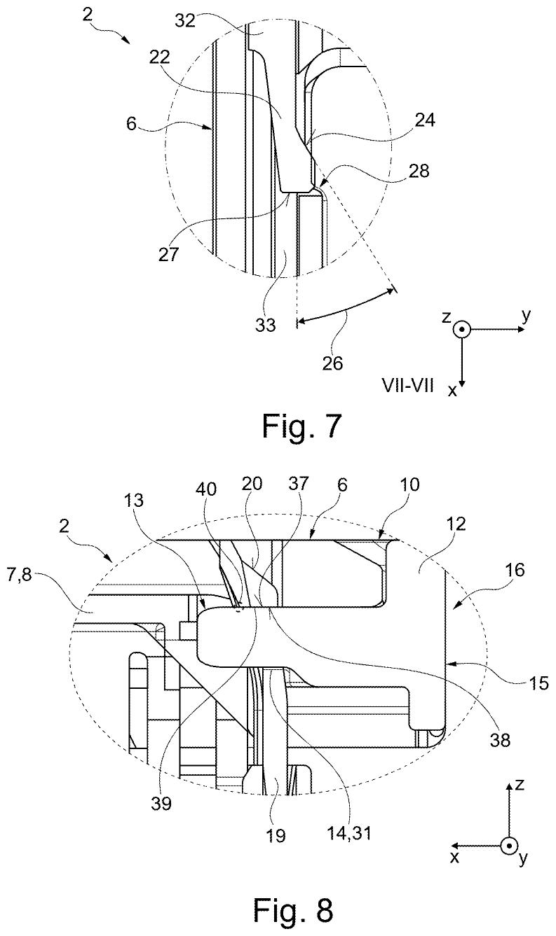

In the present example, the securing slide 12 comprises an elastically reversibly tensionable arresting element 22, wherein the actuating lever 6 comprises an arresting element receptacle 23 (see FIG. 3) which corresponds to the arresting element 22. The arresting element 22 is designed in such a way that it is arranged in a tensioned release position while the securing slide 12 is being adjusted in the direction of the securing position. The arresting element 22 is also designed in such a way that, in the securing position of the securing slide 12, said arresting element is arranged in a non-tensioned arresting position in which the arresting element 22 engages in the arresting element receptacle 23. Here, an arresting surface 24 (see FIG. 7) of the arresting element 22 lies against an edge 25 of the arresting element receptacle 23 (see FIG. 3), as a result of which the adjustment of the securing slide 12 in the direction of the securing-release position is arrested. Here, in the example, the arresting surface 24 is arranged parallel to the vertical axis z of the actuating lever 6, wherein the arresting surface 24 simultaneously forms an angle 26 with a longitudinal vertical plane XZ. In the present case, this angle 26 is greater than 0 degrees and smaller than 90 degrees, for example 30 degrees or 35 degrees. In particular, the angle 26 is configured such that—proceeding from the securing position of the securing slide 12—the securing slide 12 can only be moved out of the securing position when a predefined securing-release force is exerted counter to the X direction on the securing slide 12. In this case, the magnitude of the securing-release force is determined by the magnitude of the angle 26.

FIG. 7 shows a perspective detail view, sectioned along section plane VII-VII (see FIG. 3), of a part of the plug-in connection system 1, wherein the securing slide is arranged in the securing-release position. FIG. 7 illustrates the arresting element 22 as it is arranged in a non-tensioned blocking position. A prerequisite for the blocking position is that the locking mechanism 5 is moved out of its locking position and the securing slide 12 is arranged in its securing-release position. In the blocking position, a blocking surface 27 of the arresting element 22 abuts against a blocking element 28 of the actuating lever 6. As a result, adjustment of the securing slide 12 in the direction of the securing position, that is to say sliding of the securing slide 12 in the X direction, is blocked. In order to enable the displacement or adjustment of the securing slide 12 in the direction of its securing position, the arresting element 22 is designed in such a way that it is able to be tensioned from the blocking position into the release position by virtue of an arresting element edge 29 of the arresting element 22 sliding, with adjustment of the locking mechanism 5 into the locking position, along a sliding surface 30 of the first plug-in connection element 2. Since the locking mechanism 5 is adjusted by means of the pivoting of the actuating lever 6, the arresting element 22 is in other words tensioned from the blocking position into the release position by the adjustment of the actuating lever 6 in the direction of its second lever end position. If the actuating lever is thus pivoted in the direction of its second lever end position, the arresting element edge 29 of the arresting element 22 strikes against the sliding surface 30 of the first plug-in connection element 2 and is driven outward in the transverse direction y when the actuating lever 6 is moved further in the direction of its second lever end position, as a result of which said arresting element is adjusted into the release position. Accordingly, FIG. 4 illustrates the plug-in connection system 1, wherein the actuating lever 6 is moved out of the second lever end position and the securing slide 12 is simultaneously arranged in its securing-release position.

Reference is again made to FIG. 6. It is apparent that, in the present example, the securing pin receptacle 14 is formed by a passage opening 31 which passes completely through the latching spring bar 19 in the longitudinal direction x. This means that, in the securing position of the securing slide 12, the securing pin 13 dips into the passage opening 31 and/or projects completely through the passage opening 31. Here, provision may in particular be made for an inner wall of the passage opening 31 and an outer wall of the securing pin 13 to lie directly against one another in the securing position of the securing slide 12, such that tensioning of the latching spring bar 19 is blocked as long as the securing pin 13 is arranged in the passage opening 31.

Furthermore, it is clear from FIG. 6 that, in the present example, the securing slide 12 comprises two sliding limbs 32, wherein the actuating lever 6 comprises two sliding limb receptacles 33, and the securing slide 12 is mounted so as to be movable in translation in the actuating lever 6 by virtue of the sliding limbs 32 each being arranged in the correspondingly associated sliding limb receptacle 33. In this case, provision is in particular made for the respective sliding limb 32 to comprise the arresting element 22 or to be firmly connected to the arresting element 22. Provision may in particular be made for the respective sliding limb 32 and the respective arresting element 22 to be formed in one piece with one another or to be force-fittingly, form-fittingly and/or cohesively connected to one another. In other words, provision may be made for the respective arresting element 22 to form an extension of the respective sliding limb 32. In this case, the respective sliding limb 32 is designed, at least in certain regions, so as to be reversibly elastically tensionable.

FIG. 8 shows a sectioned detail view of a part of the plug-in connection system 1, wherein the securing slide 12 is arranged in the securing position. It is apparent in FIG. 8 how the securing pin 13 engages completely through the securing pin receptacle 14, here the passage opening 31 in the example, as a result of which pivoting out of the actuating lever 6 (that is to say about the Y axis) is inhibited. To this end, the passage opening 31 has an inner peripheral surface 38 with a tilt lock part 39 which corresponds to an outer peripheral surface 37 of the securing pin 13, wherein the tilt lock part 39 and the outer peripheral surface 37 of the securing pin 13 lie directly against one another when the securing form-fitting engagement is closed. The tilt lock part 39 extends along the X axis or longitudinal axis of the first plug-in connection element 2 over a determined length. By virtue of the passage opening 31 thus lying directly against the securing pin 13 by means of its tilt lock part 39 when the securing form-fitting engagement is produced as intended, an edge 40 of the passage opening 31 cannot be moved since the movement path required for tensioning the latching spring bar 19 is obstructed by the securing pin 13. As a result, tilting or tensioning of the latching spring bar 19 is inhibited.

FIG. 9 shows a side view of the plug-in connection system 1, wherein the securing slide 12 is arranged in the securing position. Furthermore, FIG. 9 shows that, in the present example, the first plug-in connection element 2 of the plug-in connection system 1 comprises a snap-action hook device 34 comprising a snap-action hook 35 and a snap-action hook receptacle 36 which corresponds to the snap-action hook 35. In the present case, provision is made for the first plug-in connection element 2 to comprise two or more snap-action hook devices 34, here six snap-action hook devices 34 in the example. In the present example, the respective snap-action hook 35 is firmly connected to the cover upper part 7a of the cover 7 or of the first plug-in connection element 2, whereas the respective snap-action hook receptacle 36 is firmly connected to the cover lower part 7b of the cover 7 or of the first plug-in connection element 2. In the region A, illustrated in enlarged and sectioned form, of the plug-in connection system 1 in FIG. 9, it is clear that provision is made in the present example for the latching spring bar 19 and one of the snap-action hooks 35 to be formed in one piece with one another or to be force-fittingly, form-fittingly and/or cohesively connected to one another in some other way. Due to the spatial proximity of this snap-action hook 35 to the latching spring bar 19, it is held particularly securely on the cover lower part 7b.

What is demonstrated by way of the plug-in connection system 1, the respective plug-in connection element 2, 3 and the plug-in connection 4 is a respective possibility as to how—in particular in the automotive sector—two mutually corresponding plug-in connection elements can be particularly firmly connected to one another and can be reliably kept connected.

### LIST OF REFERENCE SIGNS

1 Plug-in connection system
2 (First) plug-in connection element
3 (Second) plug-in connection element
4 Plug-in connection
5 Locking mechanism
6 Actuating lever
7 Cover
7a Cover upper part
7b Cover lower part
8 Not assigned
9 First form-fitting element
10 Actuating portion
11 Second form-fitting element
12 Securing slide
13 Securing pin
14 Securing pin receptacle
15 Actuating surface element
16 Actuating end
17 Lever extension
18 Latching projection
19 Latching spring bar
20 Sliding surface of the latching spring bar
21 Latching wedge
22 Arresting element
23 Arresting element receptacle
24 Arresting surface
25 Edge
26 Angle
27 Blocking surface
28 Blocking element
29 Arresting element edge
30 Sliding surface of the first plug-in connection element
31 Passage opening
32 Sliding limb
33 Sliding limb receptacle
34 Snap-action hook device
35 Snap-action hook
36 Snap-action hook receptacle
37 Outer peripheral surface of the securing pin
38 Inner peripheral surface of the passage opening
39 Tilt lock part
40 Edge of the passage opening

The contents of DE application no. 10 2023 104 274.2, filed 21 Feb. 2023 are hereby incorporated by reference, the same as if set forth at length.

1. Plug-in connection system (1) comprising a first plug-in connection element (2) and a second plug-in connection element (3) which correspond to one another to form a plug-in connection (4), wherein the plug-in connection system (1) further comprises:
a locking mechanism (5) comprising an actuating lever (6) which is pivotably mounted on a cover (7) of the first plug-in connection element (2) and which is pivotable between a first lever end position and a second lever end position, wherein the locking mechanism (5)
is arranged, in the second lever end position, in a locking position in which a first form-fitting element (9) of the first plug-in connection element (2) and a second form-fitting element (11) of the second plug-in connection element (3) together form a locking form-fitting engagement which tensions the plug-in connection elements (2, 3) against one another, and
is arranged, in the first lever end position, in an unlocking position in which the locking form-fitting engagement is released,
a securing slide (12) which is mounted so as to be movable in translation in the actuating lever (6) of the locking mechanism (5) and which is adjustable between
a securing position, in which a securing pin (13) of the securing slide (12) form-fittingly engages in a securing pin receptacle (14) of the cover (7), as a result of which a securing form-fitting engagement is formed between the cover (7) and the actuating lever (6), and
a securing-release position, in which the securing form-fitting engagement is released.

2. Plug-in connection system (1) according to claim 1,
wherein,
the actuating lever (6) comprises a latching projection (18) and the cover (7) comprises a latching spring bar (19) which corresponds to the latching projection (18), said latching spring bar
being arranged, in the first lever end position, in a non-tensioned starting position, being able to be reversibly elastically tensioned, with adjustment of the actuating lever (6) from its first lever end position in the direction of the second lever end position, from the starting position into a latching position by virtue of the latching projection (18) sliding along the latching spring bar (19),
being arranged, in the second lever end position, in a non-tensioned latching securing position, wherein the latching spring bar (19) and the latching projection (18) establish a latching securing connection between the actuating lever (6) and the cover (7).

3. Plug-in connection system (1) according to claim 2,
wherein,
the securing pin receptacle (14) is formed by a passage opening (31) which passes through the latching spring bar (19).

4. Plug-in connection system (1) according to claim 3,
wherein,
the passage opening (31) has an inner peripheral surface with a tilt lock part which corresponds to an outer peripheral surface of the securing pin (13), wherein the tilt lock part and the outer peripheral surface of the securing pin (13) lie directly against one another when the securing form-fitting engagement is closed.

5. Plug-in connection system (1) according to claim 1,
wherein,
the securing slide (12) comprises an elastically reversibly tensionable arresting element (22) and the actuating lever (6) comprises an arresting element receptacle (23), wherein the arresting element (22)
is arranged, with adjustment of the securing slide (12) in the direction of the securing position, in a tensioned release position,
is arranged, in the securing position of the securing slide (12), in a non-tensioned arresting position, wherein it engages in the arresting element receptacle (23) in such a way that an arresting surface (24) of the arresting element (22) lies against an edge (25) of the arresting element receptacle (23), as a result of which the adjustment of the securing slide (12) in the direction of the securing-release position is arrested.

6. Plug-in connection system (1) according to claim 5,
wherein,
the arresting surface (24) is parallel to a vertical axis (z) of the actuating lever (6) and forms an angle (26) greater than 0° and smaller than 90° with a longitudinal vertical plane (XZ).

7. Plug-in connection system (1) according to claim 5,
wherein,
when the locking mechanism (5) is moved out of its locking position and the securing slide (12) is arranged in its securing-release position, the arresting element (22) is arranged in a non-tensioned blocking position in which a blocking surface (27) of the arresting element (22) abuts against a blocking element (28) of the actuating lever (6), as a result of which adjustment of the securing slide (12) in the direction of the securing position is blocked, wherein the arresting element (22) is able to be tensioned from the blocking position into the release position by virtue of an arresting element edge (29) of the arresting element (22) sliding, with adjustment of the locking mechanism (5) into the locking position, against a sliding surface (30) of the first plug-in connection element (2).

8. Plug-in connection system (1) according to claim 1,
wherein,
the securing slide (12) in the securing-release position projects along a longitudinal direction (x) of the actuating lever (6) from an actuating end (16) of same and forms a lever extension (17) of the actuating lever (6) as a result.

9. Plug-in connection system (1) according to claim 1,
wherein,
the securing slide (12) comprises two sliding limbs (32) and the actuating lever (6) comprises two sliding limb receptacles (33), wherein the securing slide (12) is mounted so as to be movable in translation in the actuating lever (6) by virtue of the sliding limbs (32) each being arranged in the correspondingly associated sliding limb receptacle (33).

10. Plug-in connection element (2, 3) for the plug-in connection system (1) according to claim 1, wherein the plug-in connection element (2, 3) is a plug, a socket, or a mixed construction with a plug part and a socket part.

11. Plug-in connection (4) comprising the plug-in connection system designed according to claim 1.
